(19) United States
(12) Patent Application Publication
(10) Pub. No.: US 2012/0247623 A1
(43) Pub. Date: Oct. 4, 2012

(54) Optimization and Control of Metallurgical Properties During Homogenization of an Alloy

(76) Inventors: Robert A. Matuska, Heath, OH (US); David J. Shoemaker, Heath, OH (US); Mory Shaarbaf, Spokane, WA (US); Steve M. Williams, Greenville, TX (US)

(21) Appl. No.: 13/079,633

(22) Filed: Apr. 4, 2011

(51) Int. Cl. C21D 11/00; G06F 17/50; C21D 9/00

(52) U.S. Cl. 148/503; 148/511; 148/559; 700/104

(57) ABSTRACT

The homogenization cycle of an alloy is optimized and controlled by defining a target degree of transformation to achieve at least one metallurgical property for an alloy. The desired metallurgical properties include, but are not limited to, dissolving precipitation hardening phases, transforming insoluble phases into preferred phases and precipitating the dispersoid phases to the proper size and distribution. Using regression analysis, a transformation model is obtained to predict the degree of transformation of an alloy by analyzing the degree of transformation of a plurality of sample alloys subjected to heating at predetermine temperatures for predetermined amounts of time.

### BACKGROUND OF INVENTION

1. Field of the Invention

The present invention relates to a method for optimizing and controlling the metallurgical properties of an alloy during a homogenization process by predicting the degree of transformation of an alloy during homogenization.

2. Description of Related Art

Aluminum alloys are typically homogenized after casting. The purpose of the homogenization process is to:
1. Dissolve precipitation hardening phases that are segregated during the casting process to optimize the final metallurgical properties of the material.
2. Transform insoluble phases into preferred phases that facilitate downstream working operations (such as extrusion or rolling).
3. Precipitate the dispersoid phases that are in solid state solution from the casting process to the proper size and distribution to optimize the final metallurgical properties of the material.

The homogenization process for aluminum alloys has been controlled historically by heating the subject material to a set temperature range (soak temperature) and holding that material for a designated time (soak time). This method of control assumes either a consistent heating rate of the material or ignores the amount of transformation that occurs during the heat-up completely. This historical method of control is depicted graphically in FIGS. 1-3. FIG. 1 depicts the hypothetical limits for the metallurgical transformations described above. FIG. 2 depicts the historical control goals which assume isothermal conditions throughout the soak. FIG. 3 depicts the more realistic control goals with dynamic temperature and time conditions.

The historical method of control results in inconsistent material properties after homogenization as a result of failing to account for the portion of the metallurgical reaction that occurs during the heat-up portion of the cycle and the variation within that batch that potentially occurs. Larger batch sizes, with slower heating rates, have greater temperature exposure than smaller batches with faster heating rates and the same soak time and temperature. In addition to this, variation in temperature throughout a batch makes it difficult to assure that the coldest part of the batch received enough time at temperature for the desired metallurgical reactions to occur, while the hottest part of the batch may receive too much time at temperature, resulting in coarsening of the dispersoid phases. This is depicted in the differences between FIGS. 2 and 3, where temperature is shown as being dynamic and represented by a control range that was achieved at different times at various positions throughout the load.

### BRIEF SUMMARY OF THE INVENTION

One aspect of the present invention is to provide a method for optimizing and controlling the homogenization of an alloy in a furnace. The method includes defining a target degree of transformation to achieve at least one metallurgical property for the alloy. The desired metallurgical properties include, but are not limited to, dissolving precipitation hardening phases, transforming insoluble phases into preferred phases and precipitating the dispersoid phases to the proper size and distribution. Using regression analysis, a transformation model is obtained to predict the degree of transformation of an alloy by analyzing the degree of transformation of a plurality of sample alloys subjected to heating at predetermine temperatures for predetermined amounts of time. The homogenization process is controlled and optimized by monitoring the temperature of the alloy at incremental time periods through-out the heat-up and soaking portion of the homogenization process to incrementally calculate the degree of metallurgical transformation using the transformation model. Each incremental calculation of the degree of metallurgical transformation is recorded to achieve a total amount of metallurgical transformation. Using the transformation model, the total amount of time in the furnace is calculated to achieve the target degree of transformation.

This homogenization integration process assures that the target metallurgical reactions and properties are met consistently throughout the homogenization load, within the capabilities of the furnace. By controlling the homogenization process via homogenization integration, the metallurgical properties of the material relative to mechanical properties (including, but not limited to: yield strength, ultimate strength, elongation, fracture toughness and fatigue life); workability in downstream operations (including, but not limited to: extrusion, forging and rolling); and improved surface finish of the final product after working are optimized to the target levels desired for the end use application.

### BRIEF DESCRIPTION OF THE DRAWINGS

The features and advantages of the present invention will become apparent from the following detailed description of a preferred embodiment thereof, taken in conjunction with the accompanying drawings, in which:

FIG. 1 depicts the hypothetical limits for the metallurgical transformations using historical controls;

FIG. 2 depicts the historical control goals which assume isothermal conditions throughout the soak;

FIG. 3 depicts the more realistic control goals with dynamic temperature and time conditions using historical controls;

FIG. 4 is a graph showing the representative time/temperature study for development of the homogenization integration model according to the present invention;

FIG. 5 is a graph showing Parameter A (% transformation/s) as a function of temperature using the homogenization integration model according to the present invention;

FIG. 6 is a graph showing the transformation rate relative to degree of transformation using the homogenization integration model according to the present invention; and

FIG. 7 are pictures showing the metallographic examination of ingot with lab homogenization, ingot with homogenization integration cycle, and ingot with standard homogenization.

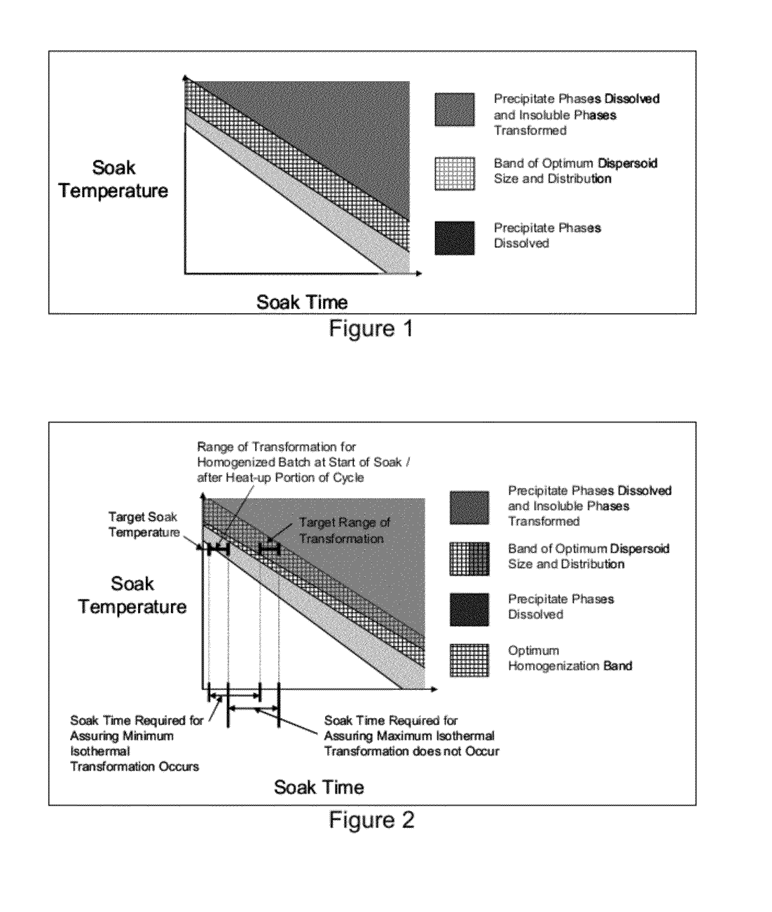

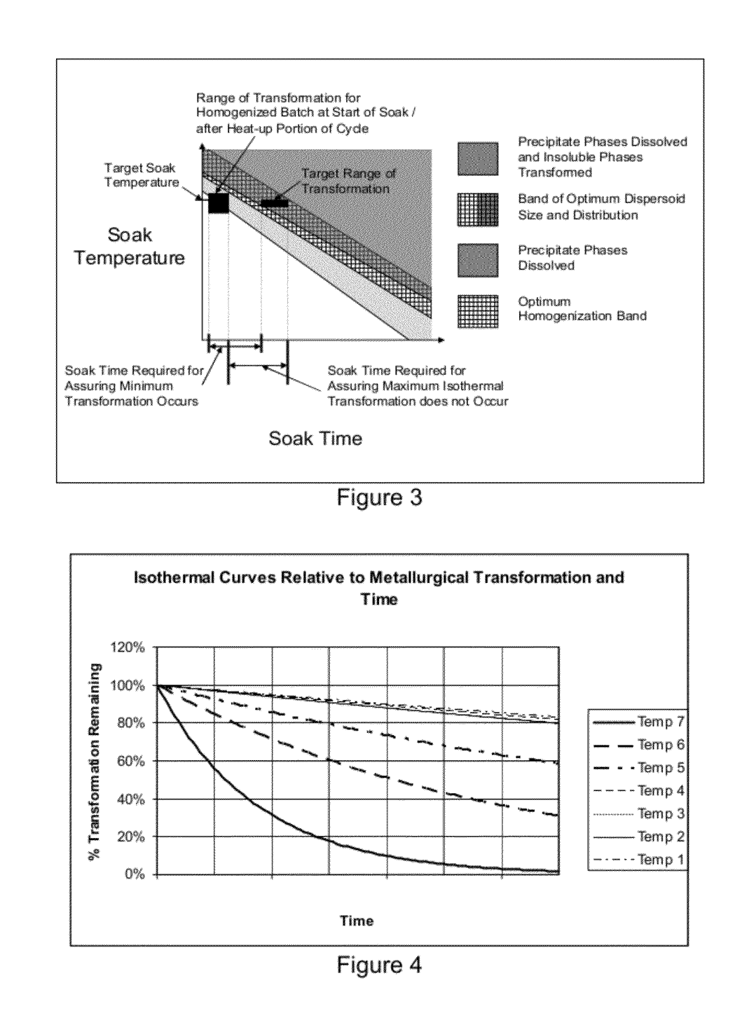

### DETAILED DESCRIPTION OF THE INVENTION

The present invention is directed to a method for optimizing and controlling the homogenization process used for an alloy, such as an as-cast alloy, prior to further processing operations. This is accomplished by characterizing the metallurgical properties of the homogenized alloy in terms of the total degree of metallurgical transformation. As-cast samples of the alloy are heated at various temperatures with relatively fast heating rates, held for a finite period of time, and water quenched to stop any further metallurgical reaction (thus eliminating any cooling rate effects). The degree of metallurgical transformation of each sample is then determined via standard laboratory techniques, such as differential scanning calorimetry, metallographic examination and scanning electron microscopy. This provides isothermal curves relating degree of metallurgical transformation to time at a given temperature as shown in FIG. 4.

This data is then converted into a transformation model as a function of time for a set temperature based on the best curve fit. Preferably, the transformation model is set up using an exponential regression method with data from a plurality of samples of the alloy with associated degrees of metallurgical transformation at a given time and a given temperature. Assuming an exponential relationship, this gives the following equation:

ω=e^{-At}

where: ω=percent transformation; A=temperature specific fitting parameter (unit is s⁻¹); t=time (in seconds).

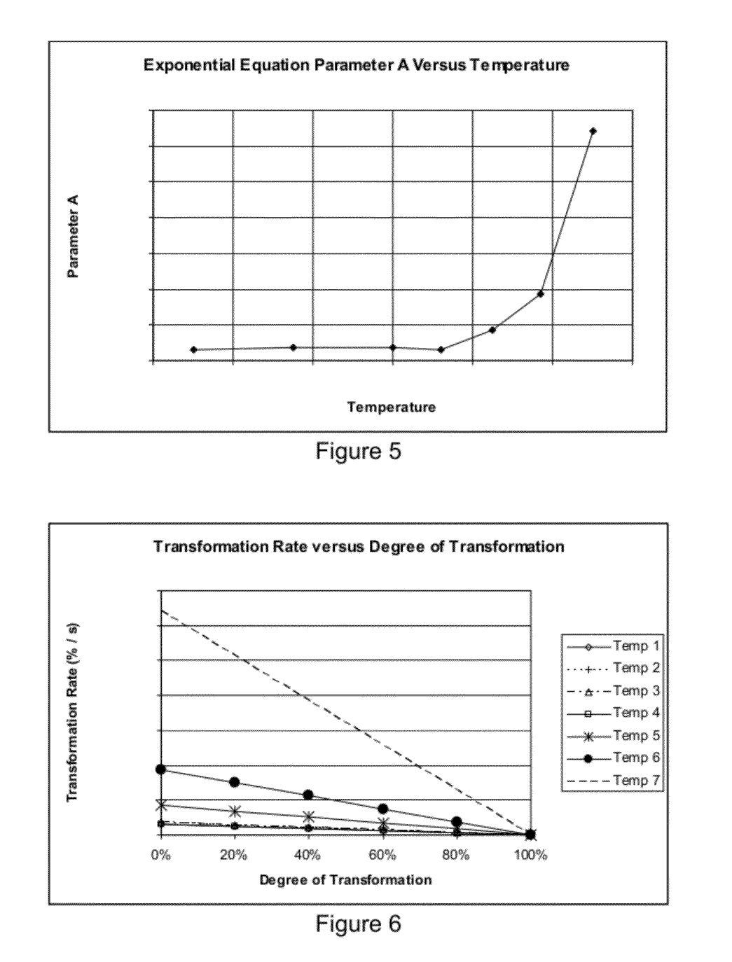

Continuing to assume an exponential relationship, A is calculated for each temperature with results as shown in FIG. 5. Using this information, the actual amount of phases left untransformed (ψ—or degree of metallurgical transformation) can be determined by the following formula:

ψ=1−ω

or

ω=1−e^{-At}

The rate of metallurgical transformation must be determined as a function of time. This can then be integrated over time to predict the degree of metallurgical transformation. If integrated over long periods of time, this relationship is destroyed, as a result of the dynamic nature of temperature throughout the cycle affecting the metallurgical transformation rate. Therefore, rather than expressing the metallurgical transformation rate as a function of time, it is converted into a function of degree of metallurgical transformation as shown below.

ψ=1−e^{-At}

ψ′=dψ/dt

ψ′=A e^{-At}

ψ=A(1−ψ)

Plotting the metallurgical transformation rate (ψ′) relative to the degree of metallurgical transformation (ψ), gives the relationship shown in FIG. 6.

Since the metallurgical transformation rate is dependant on A for a given temperature, the results from FIG. 5 are used to determine A for a given temperature.

The transformation model is then complete with the following equations:

A=Be^{CT}

ψ′=A(1−ψ)

ψ′=Be^{CT}(1−ψ)

where: ψ=degree of metallurgical transformation; ψ′=metallurgical transformation rate; A=temperature specific fitting parameter; t=time, B and C are alloy dependent constants for the exponential relationship of A relative to temperature (T).

The metallurgical transformation rate can then be solved by using either a predicted or measured temperature for an incremental time period and determining the transformation rate for this incremental time period as a function of the accumulated degree of transformation up to that point in the cycle. This results in a new degree of transformation that is continuously monitored as a control parameter and used in the next calculation for phase transformation rate.

In one embodiment, the method for optimizing the homogenization process uses a computer program embodied on a computer readable medium (also referred to herein as homogenization integration control software) for optimizing the homogenization process of an alloy in which the alloy is produced from an input stock where production conditions are detected on-line throughout the entire homogenization process, wherein the metallurgical properties to be expected of the alloy are calculated in advance. It is understood by those of skill in the art that the time and temperature of an alloy in an homogenization process may be recorded using a variety of known devices. For example, in practice, a load thermocouple would be used as an input into the homogenization integration control software. The calculation per the above formulas would then be used to determine the incremental degree of metallurgical transformation and this would be added to the accumulated metallurgical transformation established from the start of the cycle. An alternative method of control would be to use an air thermocouple to monitor the furnace cycle, and use an established relationship between the air and load temperatures to predict the load temperature. This information would then be used as in input into the homogenization integration control software to determine the desired degree of metallurgical transformation for an incremental portion of the cycle. The software then tracks the total degree of metallurgical transformation and determines the amount of time in the furnace based on metallurgical transformation, rather than a time at a given temperature. This process of controlling and optimizing the homogenization process of an alloy using the above-defined transformation model is also referred to herein as “homogenization integration control”.

The transformation model accurately provides a quantitative predictor of the degree of transformation in an alloy as a function of time and temperature both during heat-up and soaking regardless of the batch size. The present transformation model provides a means to predict the degree of transformation necessary to obtain an alloy with desirable properties. More particularly, the transformation model of the present invention can be applied to quantitatively predict the degree of transformation in aluminum alloys. By way of example, the application of the transformation model to a 6061 aluminum alloy homogenization process is described below. It is to be understood though that the transformation model of the current invention can be applied to any alloy composition.

This method of control provides significant productivity gains in the homogenization cycle itself, but also provides greater consistency in the homogenized product. This consistency allows downstream operations (including, but limited to extrusion, rolling and forging) to also be optimized, rather than planning for the worst case homogenized structure, as has been done historically with conventional control methods. This results in significant productivity gains in these processes as well.

### EXAMPLES

The following examples are put forth so as to provide those of ordinary skill in the art with a complete disclosure and description of how the compounds, compositions, articles, devices, and/or methods described and claimed herein are made and evaluated, and are intended to be purely exemplary and are not intended to limit the scope of what the inventors regard as their invention. Efforts have been made to ensure accuracy with respect to numbers (e.g., amounts, temperature, etc.) but some errors and deviations should be accounted for. Unless indicated otherwise, parts are parts by weight and pressure is at or near atmospheric. There are numerous variations and combinations of conditions, e.g., alloy composition, temperatures, pressures and other ranges and conditions that can be used to optimize the methods described herein. Only reasonable and routine experimentation will be required to optimize such process conditions.

### Example 1

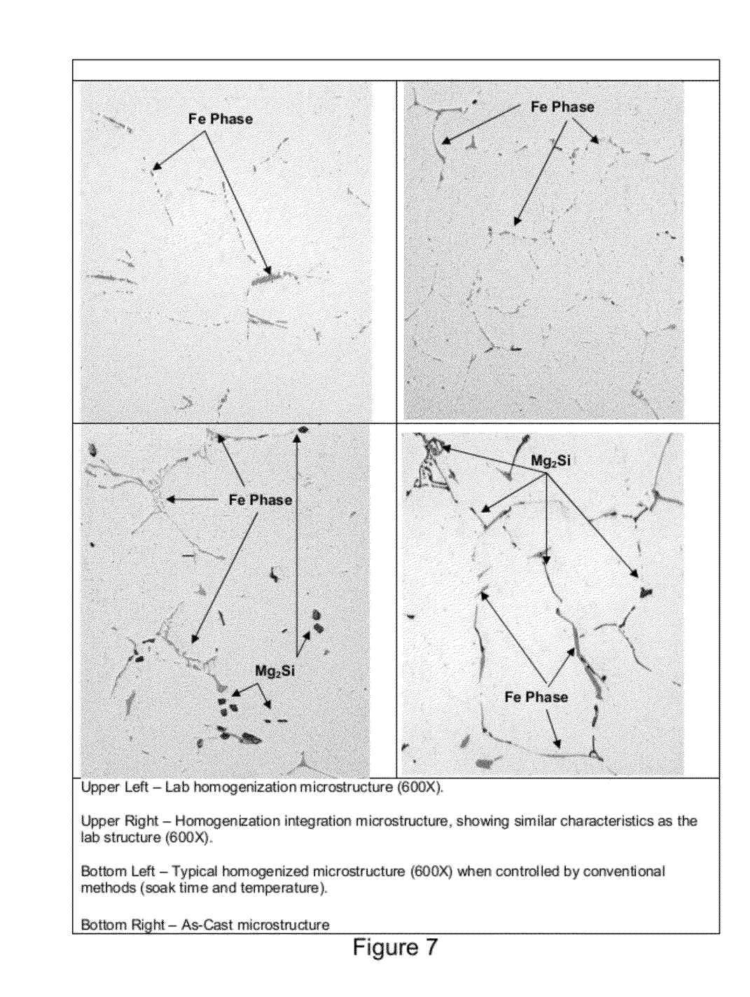

An as-cast sample of aluminum alloy 6061 was homogenized at 1050° F. for four hours in a lab furnace to assure 100% Fe transformation from β to α and 100% transformation of Mg₂Si from undissolved to dissolved phases. Similar samples of 6061 were homogenized in production furnaces—one using homogenization integration control targeting 100% transformation of both Fe and Mg₂Si and the other using a typical time and temperature soak control. The results of all three samples were evaluated via DSC to determine degree of Fe and Mg₂Si transformation. The results are shown in Table 1. The samples were also evaluated metallographically with the results shown in FIG. 7. FIG. 7 shows the transformations of a 6061 alloy. Note that all of the Mg₂Si is dissolved relative to the as-cast structure. Also note that the Fe phases are transformed from continuous, sharp sickle shaped phases to rounded spheroidal shapes (indicating the metallurgical transformation of the insoluble phases).

TABLE 1
DSC Analysis of Lab versus Production Homogenization
Integration Transformations

| | | Produc- | Lab | Production |
|---|---|---|---|---|
| | Lab β | tion β | Dissolve | Dissolve |
| | to α Fe | to α Fe | Mg₂Si | Mg₂Si |
| Energy Required for Further | 0 J/g | 0 J/g | 0 J/g | 0 J/g |
| Transformation Lab vs. | | | | |
| Production Homogenization | | | | |
| Integration | | | | |
| Energy Required for Further | 0 J/g | 0.28 J/g | 0 J/g | 3.24 J/g |
| Transformation Lab vs. | | | | |
| Typically Controlled | | | | |
| Production Furnace | | | | |

The typically controlled production furnace results indicate that the Fe transformation was 38% complete, while the Mg₂Si was 40% complete relative to the desired. This is compared to the homogenization integration controlled cycle that achieved 100% transformation.

The Mg₂Si being completely dissolved in aluminum 6XXX alloys is beneficial especially for products that planned to be quenched from hot working operations as a solution heat treatment (i.e. extrusion). This provides greater consistency in mechanical properties as well as limits the potential for isolated melting of the Mg₂Si (incipient melting) during the hot working operation, which results in hot shortness surface cracking and is typically overcome by reducing extrusion speeds, and thus productivity. The Fe transformation also significantly improves potential extrusion speeds. The long, sickle shaped Fe phases, as shown in the as-cast and conventional homogenization controlled cycle tear the surface of the metal as it is being hot worked, particularly during extrusion. The degree of surface tearing is proportional to the strain rate, and thus this condition is also typically corrected by slowing the hot working speeds, and thus productivity.

### Example 2

A conventional soak temperature and time strategy was developed for a furnace to assure all target metallurgical transformations were achieved. The average cycle time was recorded for this process and determined to be 520 minutes. The homogenization integration control was then implemented on this same furnace and the average cycle time for the same product was determined to be 447 minutes. Both cycles achieved equivalent transformations, but the homogenization integration control provided greater target consistency and achieved a 14% improvement relative to the original control strategy. The reason for this difference in productivity was the control method had to assume the slowest potential heat-up rate for the material to ensure full metallurgical transformation. Since the homogenization integration control system accounts for the metallurgical transformation during the heat-up rate, material that receives faster heat-up rates can be held at soak temperatures for shorter periods of time. Despite the variation in soak times, the product is controlled to a target degree of metallurgical transformation and thus the consistency of the product is dramatically improved.

### Example 3

Production samples of aluminum billet were homogenized using a furnace with homogenization integration control were extruded and compared with billets of the same alloy homogenized on a different furnace for approximately the same cycle time and target temperature without homogenization integration control (conventional control). The differences in microstructure are shown in FIG. 7. The billet was used to extrude over 20 different shapes. The extrusion rates of these 20 shapes were 15-25% faster with the homogenization integration controlled billet as compared to the conventionally controlled billet. Not only were the extrusion rates significantly greater, but the surface quality of the extrusion also improved significantly.

### Example 4

The surface roughness of extrusions made from billets homogenized using conventional control techniques were compared to extrusions made from billets using homogenization integration control. The average surface roughness of the extrusions from conventionally controlled homogenized billet was 94.9 Ra, while the average surface roughness of the extrusions from homogenization integration controlled billets resulted in a surface roughness of 33.3 Ra. The observations from each location spanned 20 production orders from each billet condition.

Although the present invention has been disclosed in terms of a preferred embodiment, it will be understood that numerous additional modifications and variations could be made thereto without departing from the scope of the invention as defined by the following claims:

What is claimed is:

1. A method for optimizing an homogenization process of an alloy, comprising
a) defining a target degree of metallurgical transformation to achieve at least one metallurgical property for the alloy;
b) providing a transformation model that predicts the degree of transformation of the alloy, said transformation model is obtained by analyzing the degree of metallurgical transformation of a plurality of samples of the alloy subjected to heating at predetermined temperatures for predetermined amounts of time;
c) introducing a billet of the alloy to a homogenization cycle;
d) incrementally measuring the temperature of the alloy during the homogenization cycle at an incremental time period to predict an incremental degree of metallurgical transformation according to the phase transformation model; and
e) controlling the total amount of time the alloy is subjected to the homogenization cycle by accumulating each incremental degree of metallurgical transformation until the total amount of time in the homogenization cycle provides the target degree of metallurgical transformation.

2. The method of claim 1, wherein said homogenization cycle includes a heat-up portion and a soak portion

3. The method of claim 1, wherein said phase transformation model is expressed mathematically as:
A=Be^{CT}
ψ′=A(1−ψ)
ψ′=Be^{CT}(1−ψ)
Wherein, ψ=degree of metallurgical transformation; ψ′=metallurgical transformation rate; A=temperature specific fitting parameter; B and C are alloy dependent constants for the exponential relationship of A relative to temperature (T).

4. The method of claim 1, wherein said alloy is an aluminum alloy.

5. The method of claim 1, wherein the at least one metallurgical property is selected from the group consisting of dissolving precipitation hardening phases, transforming insoluble phases into preferred phases, and precipitating the dispersoid phases to the proper size and distribution.

6. The method of claim 1, further comprising
computer optimizing and controlling the total amount of time the alloy is subjected to the homogenization cycle to achieve the at least one metallurgical property based upon the transformation model.

7. The method of claim 1, further comprising
setting up the transformation model by means of an exponential regression method with data from the plurality of samples of the alloy with associated degrees of metallurgical transformation at a given time and a given temperature.

8. A method for controlling the homogenization of aluminum alloys that integrates the incremental metallurgical reaction over the time and temperature of the homogenization cycle.

9. The method of claim 8 where the control is used to achieve a target percentage of dissolvable phases that are placed into solution.

10. The method of claim 8 where the control is used to achieve a target percentage transformation of undissolvable phases.

11. The method of claim 8 where the control is used to achieve the optimum size and distribution of dispersoid phases.

12. The method of claim 8 where the control is used to achieve the optimum surface finish of downstream operations; including extrusion, forging and rolling.

13. The method of claim 8 where the control is used to achieve maximum productivity of downstream operations; including extrusion, forging and rolling.

14. The method of claim 8 where the control is used to achieve optimum mechanical properties; including yield strength, ultimate strength, elongation, fracture toughness and fatigue.

15. The method of claim 8 where the control is used to optimize the productivity of the homogenization operation.

16. A computer program embodied on a computer readable medium for optimizing an homogenization process of an alloy in which the alloy is produced from an input stock where production conditions are detected on-line throughout the entire homogenization process, wherein the metallurgical properties to be expected of the alloy are calculated in advance, comprising
a) defining a target degree of metallurgical transformation to achieve at least one metallurgical property for the alloy;
b) providing a transformation model that predicts the degree of transformation of the alloy, said transformation model is obtained by analyzing the degree of metallurgical transformation of a plurality of samples of the alloy subjected to heating at predetermined temperatures for predetermined amounts of time;
c) incrementally measuring the temperature of the alloy during the homogenization cycle at an incremental time period to predict an incremental degree of metallurgical transformation according to the phase transformation model; and
d) controlling the total amount of time the alloy is subjected to the homogenization cycle by accumulating each incremental degree of metallurgical transformation until the total amount of time in the homogenization cycle provides the target degree of metallurgical transformation.

17. The computer program embodied on a computer readable medium of claim 16, wherein said phase transformation model is expressed mathematically as:
A=Be^{CT}
ψ′=A(1−ψ)
ψ′=Be^{CT}(1−ψ)
wherein, ψ=degree of metallurgical transformation; ψ′=metallurgical transformation rate; A=temperature specific fitting parameter; B and C are alloy dependent constants for the exponential relationship of A relative to temperature (T).

18. The computer program embodied on a computer readable medium of claim 16, further comprising
setting up the transformation model by means of an exponential regression method with data from the plurality of samples of the alloy with associated degrees of metallurgical transformation at a given time and a given temperature.
